(19) United States
(12) Patent Application Publication
(10) Pub. No.: US 2008/0264767 A1
(43) Pub. Date: Oct. 30, 2008

(54) PUSH BUTTONS

(75) Inventors: WU-KUANG CHEN, Tu-Cheng (TW); HAO-ZHUAN LIN, Shenzhen (CN); XIAO-SHE BIAN, Shenzhen (CN); YONG-CHUAN YANG, Shenzhen (CN); BAI-DA YU, Shenzhen (CN); QIANG ZHAO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen)CO., LTD., Shenzhen City (TW); HON HAI PRECISION INDUSTRY CO., LTD., Tu-Cheng (TW)

(21) Appl. No.: 11/964,732

(22) Filed: Dec. 27, 2007

(30) Foreign Application Priority Data
Apr. 26, 2007 (CN) 200710200514.1

(51) Int. Cl. H01H 13/04

(52) U.S. Cl. 200/333

(57) ABSTRACT

An exemplary push button (10) includes a main body (12) made of a ceramic material; and a connecting portion (14) integrally formed with the main body. The push button has an improved performance and is scratch resistance.

### BACKGROUND OF THE INVENTION

1. Field of the Invention

The present invention generally relates to push buttons, and more particularly to a push button used in an electronic device.

2. Discussion of the Related Art

In recent years, there has been an increase in demand for portable electronic devices, such as personal digital assistants (PDAs), mobile phones, MP3 players, and MP4 players. Push buttons as input means are common for these portable electronic devices.

Most push buttons (input keys) are made of plastic. This is due to the fact that plastic has a low melting point and good fluidity, thus plastic can be easily molded into various shapes. Raw materials for making plastic products are cheap, manufacturing plastic products by injection molding are also cheap, and adding colors to the surface of the plastic products, to improve its appearance, is simple.

However, a surface hardness of the push button made of plastic components is generally low, and the push buttons made of plastic are prone to deformed and/or scratched.

Some push buttons are made of metals because of the surface hardness of the metals. However, these metal push buttons can also be scratched and are prone to oxidation and color fading.

Therefore, a new push button is desired in order to overcome the above-described shortcomings.

### SUMMARY

A push button includes a main body made of a ceramic material, and a connecting portion integrally formed with the main body.

Other novel features will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating principles of the present push buttons. Moreover, in the drawings, like reference numerals designate corresponding parts throughout several views, and all the views are schematic.

FIG. 1 is an exploded, isometric view of a push button in accordance with a first preferred embodiment of the present invention.

FIG. 2 is an assembled, side, cross-sectional view of the push button of FIG. 1.

FIG. 3 is a side, cross-sectional view of a push button in accordance with a second preferred embodiment of the present invention.

### DETAILED DESCRIPTION OF THE EMBODIMENTS

Reference will now be made to the drawings to describe preferred embodiments of push buttons in detail.

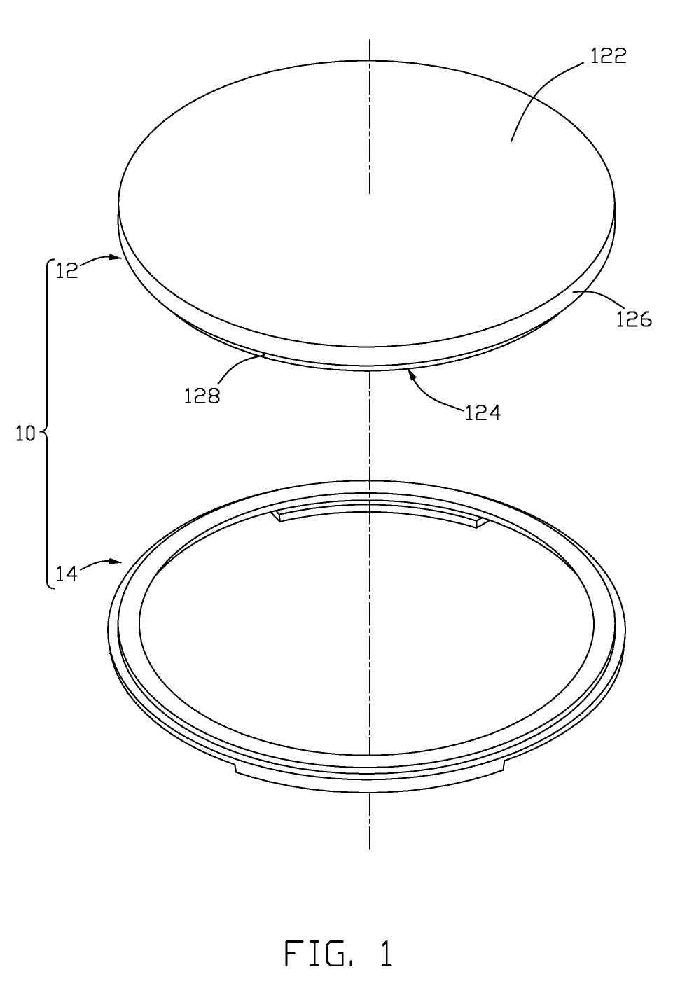

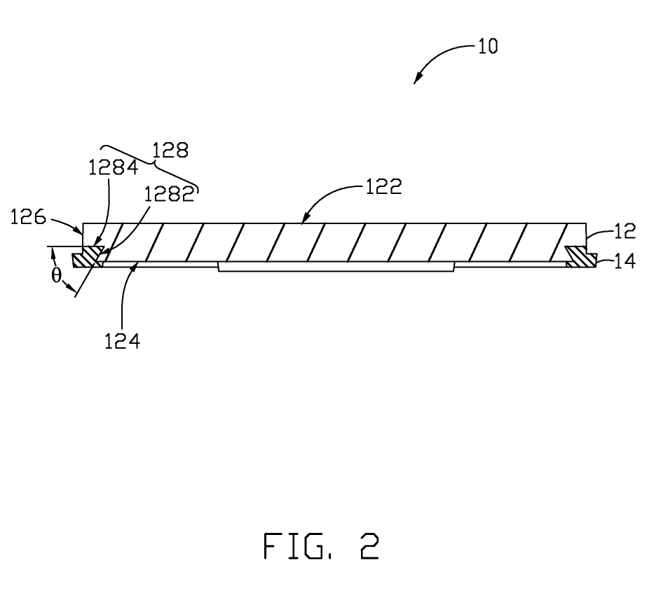

Referring to FIGS. 1 and 2, a push button 10 (input key) according to a first embodiment is shown. The push button 10 can be utilized in portable electronic devices, such as personal digital assistants (PDAs), mobile phones, MP3 players, and MP4 players. The push button 10 includes a main body 12 and a connecting portion 14. The connecting portion 14 is integrally formed with the main body 12. The main body 12 is made of a ceramic material. The ceramic material can be selected from a group consisting of zirconia, alumina, and any combination thereof. The connecting portion 14 can be made of metal or plastic. A top plan view of the push button 10 can be circular. In alternative embodiments, the top plan view of the push button 10 can be elliptical or polygonal.

To prepare the main body 12, a configuration of the main body 12 can be simplified. In the illustration embodiment, the main body 12 includes a top surface 122, a bottom surface 124 opposite to the top surface 122, a side surface 126 between the top surface 122 and the bottom surface 124, and a locking groove 128 defined between the bottom surface 124 and the side surface 126. The top surface 122 and the bottom surface 124 are circular. The side surface 126 is cylindrical in shape. The locking groove 128 encircles the side surface 126. That is, the locking groove 128 extends along the side surface 126. A vertical cross-section of the locking groove 128 is V-shaped. The locking groove 128 is formed by a first sidewall 1282 and a second sidewall 1284. The first sidewall 1282 connects with the bottom surface 124. The second sidewall 1284 connects with the side surface 126 and is parallel to the bottom surface 124. An angle θ defined between the first sidewall 1282 and the second sidewall 1284 can be in a range from about 50 degrees to about 70 degrees.

The connecting portion 14 is connected to the main body 12 with a portion of the connecting portion 14 received/formed in the locking groove 128 of the main body 12. The connecting portion 14 may be used as a component having a complicated structure of the portable electronic device, such as a component that connects the main body 12 with a housing of the portable electronic device.

An exemplary method for manufacturing the push button 10 includes: first, a semi-finished main body is formed by dry pressing a ceramic material; second, the main body 12 is formed by surface treating and polishing the semi-finished main body; third, the main body 12 is placed in a mold, then melted plastic or metal is injected in the locking groove 128 of the main body 12, thereby forming the connecting portion 14.

Because the main body 12 is made of the ceramic material, a surface hardness of the push button 10 will be enhanced, and a scratch resistant property of the push button 10 is improved. Furthermore, by varying ingredients of the ceramic material, the main body 12 may have various colors, such as red, yellow, green, blue, black, grey, and, white, and may further be translucent or transparent. Color retention properties of the ceramic material is excellent, thus the appearance of main body 12 is improved. Therefore the push button 10 has an aesthetic appearance, and furthermore an appearance of the portable electronic device can be improved.

In addition, because the connecting portion 14 is prepared by injection molding, even if a configuration of the connecting portion 14 is complicated, the connecting portion 14 can be easily formed. Furthermore, because the portion of the connecting portion 14 is received in the locking groove 128, the bonding strength between the main body 12 and the connecting portion 14 is enhanced. Still further, in general, because the connecting portion 14 is integrally formed with the main body 12, an assembling process of the push button 10 is simplified, and an assembly efficiency is improved.

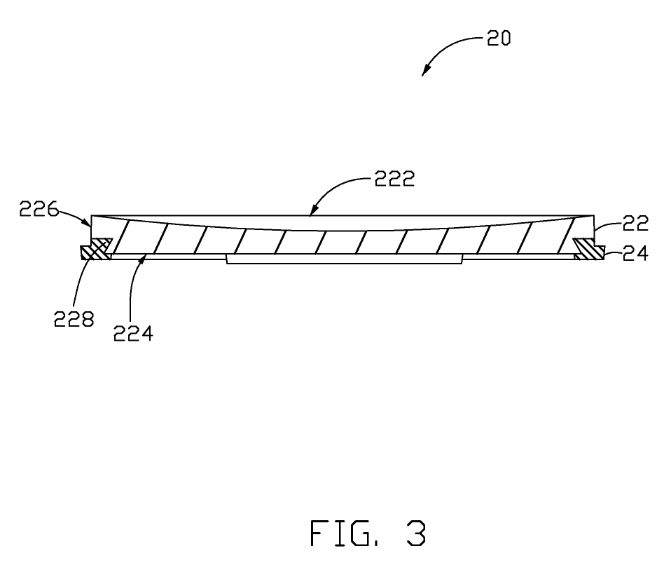

Referring to FIG. 3, a push button 20 according to a second embodiment is shown. The push button 20 includes a main body 22 and a connecting portion 24 integrally formed with the main body 24. The main body 22 includes a top surface 222, a bottom surface 224, a side surface 226, and a locking groove 228. The top surface 222 is a concave surface. The concave surface of the top surface 222 may have a better look and feel to the user. In an alternative embodiment, the top surface can be a convex surface or a planar surface.

It is noted that the scope of the present push buttons is not limited to the embodiments described above. For example, if the sidewalls of the locking grooves 128, 228 have rough surfaces, or the sidewalls of the locking grooves 128, 228 define a plurality of micro-depressions thereon, the bonding strength between the pressing bodies 12, 22 and the connecting portions 14, 24 can be further enhanced. In addition, the locking grooves 128, 228 cannot encircle the side surfaces 124, 224. The locking grooves 128, 228 can be directly defined in the side surface 126, 226 or the bottom surfaces 124, 224. The push buttons 10, 20 can be utilized in some devices other than the portable electronic devices, such as a table computer.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A push button, comprising:
a main body made of a ceramic material; and
a connecting portion integrally formed with the main body.

2. The push button as claimed in claim 1, wherein the ceramic material is selected from a group consisting of zirconia, alumina, and any combination thereof.

3. The push button as claimed in claim 1, wherein the connecting portion is made of metal or plastic.

4. The push button as claimed in claim 1, wherein a top plan view of the main body is circular, elliptical or polygonal.

5. The push button as claimed in claim 1, wherein the main body defines a locking groove, and at least a portion of the connecting portion is inserted the locking groove.

6. The push button as claimed in claim 5, wherein the main body comprises a top surface, a bottom surface opposite to the top surface, and a side surface between the top surface and the bottom surface, the locking groove is configured in the side surface.

7. The push button as claimed in claim 6, wherein a cross-section of the locking groove is V-shaped.

8. The push button as claimed in claim 7, wherein the locking groove has a first sidewall connecting the bottom surface and a second sidewall connecting the side surface, and an angle defined by the first sidewall and the second sidewall is in a range from about 50 degrees to about 70 degrees.

9. The push button as claimed in claim 6, wherein the locking groove encircles the side surface.

10. The push button as claimed in claim 6, wherein at least one of the first sidewall and the second sidewall has a rough surface.

11. The push button as claimed in claim 6, wherein the top surface is planar, concave or convex.
